(19) United States
(12) Patent Application Publication
(10) Pub. No.: US 2008/0297345 A1
(43) Pub. Date: Dec. 4, 2008

(54) ALARM DEVICE FOR A NOTEBOOK

(76) Inventor: Mike Chen, Irvine, CA (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/755,574

(22) Filed: May 30, 2007

(51) Int. Cl. G08B 13/00

(52) U.S. Cl. 340/568.1

(57) ABSTRACT

An alarm device for a notebook, including a housing, a circuit board, a press key module, a sensing unit and an alarm unit. The housing is a flat housing. A bottom face of the housing is attachable to a surface of the notebook. An upper section of the housing is formed with an arced edge. The press key module is arranged on the surface of the housing for a user to operate to generate control signals. The circuit board, the sensing unit and the alarm unit are arranged in the housing. The sensing unit serves to sense respective tilting or vibration states and output a sensing signal to the circuit board. The circuit board includes various related electronic components and a rechargeable battery for supplying power for the circuit board. The circuit board serves to accept the control signals from the press key module and the sensing signals from the sensing unit and output an alarm signal to the alarm unit. The alarm unit serves to accept the alarm signal from the circuit board to produce alarm sound/light.

### BACKGROUND OF THE INVENTION

The present invention is related to an alarm device for a notebook, and more particularly to an alarm device for a notebook, which is directly combined with the housing of the notebook. It is convenient to use the alarm device.

A notebook or other portable electronic products are carried with a user. However, it is hard to fix the notebook by way of tying. Therefore, generally, the housing of the notebook or the portable electronic product is formed with a lock hole. A lock device with a shape corresponding to the lock hole can be inserted into the lock hole to achieve a burglarproof effect. A user must carry a key for unlocking the lock device. This is inconvenient to the user.

### SUMMARY OF THE INVENTION

It is therefore a primary object of the present invention to provide an alarm device for a notebook, which is directly combined with the housing of the notebook. It is unnecessary for a user to additionally carry a key so that it is convenient for the user to use the alarm device.

It is a further object of the present invention to provide the above alarm device for the notebook, which is very thin and formed with an arced edge. This makes it difficult for a burglar to disassemble/damage the alarm device so that the burglarproof effect can be ensured.

It is still a further object of the present invention to provide the above alarm device for the notebook, in which the sounding holes for the audio output circuit are formed on a short vertical sidewall of the housing. Therefore, a burglar cannot easily shade the sounding holes to muffle the alarm sound. In addition, the alarm sound can be magnified and spread via the surface of the housing of the notebook so as to achieve better warning effect.

It is still a further object of the present invention to provide the above alarm device for the notebook. A user can use the press keys to activate or shut off the internal burglarproof circuit. This is convenient to the user.

According to the above objects, the alarm device for the notebook of the present invention includes a housing, a circuit board, a press key module, a sensing unit and an alarm unit. The housing is a flat housing. A bottom face of the housing is attachable to a surface of the notebook. The circuit board is arranged in the housing for accepting respective control signals and sensing signals to output an alarm signal. The press key module is disposed on a surface of the housing to generate the control signals. The control signals are input to the circuit board for controlling the related electronic parts to provide respective preset functions. The sensing unit serves to sense respective tilting or vibration states and output the sensing signals to the circuit board. The alarm unit serves to accept the alarm signal from the circuit board to produce corresponding alarm sound/light.

The present invention can be best understood through the following description and accompanying drawings wherein:

### BRIEF DESCRIPTION OF THE DRAWINGS

FIG. 1 is a perspective exploded view of the alarm device of the present invention;

FIG. 2 is a perspective assembled view of the alarm device of the present invention;

FIG. 3 is a side view of the alarm device of the present invention;

FIG. 4 is a block circuit diagram of the alarm device of the present invention; and

FIG. 5 shows the use of the alarm device of the present invention.

### DETAILED DESCRIPTION OF THE PREFERRED EMBODIMENTS

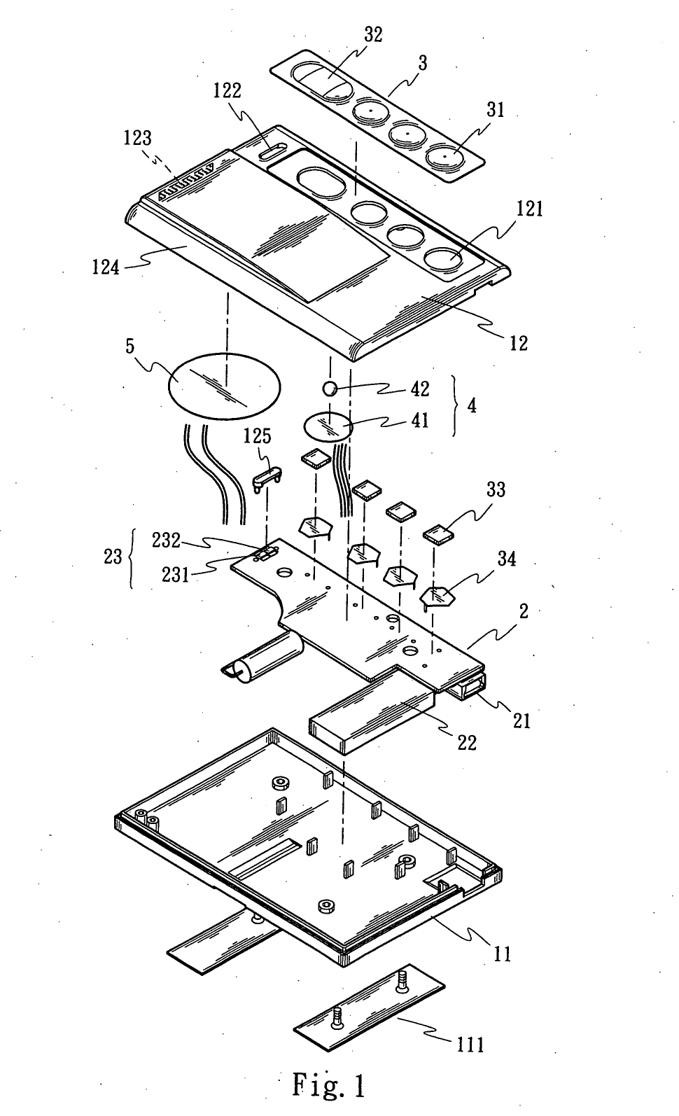

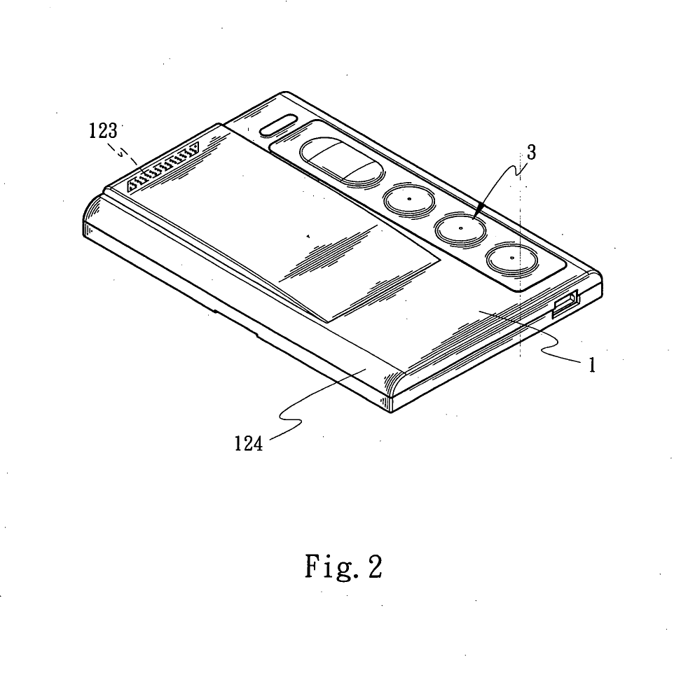

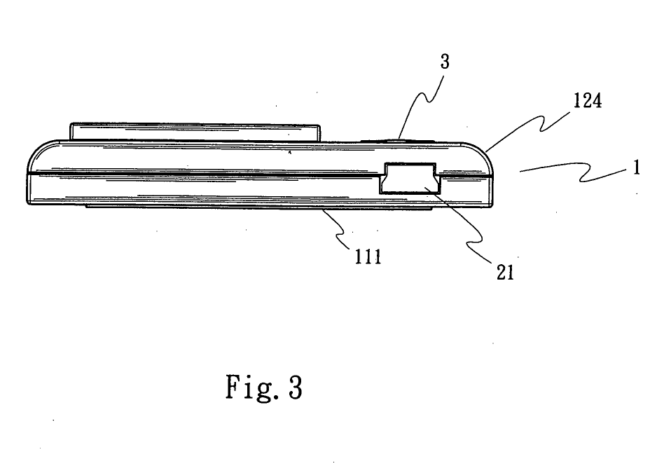

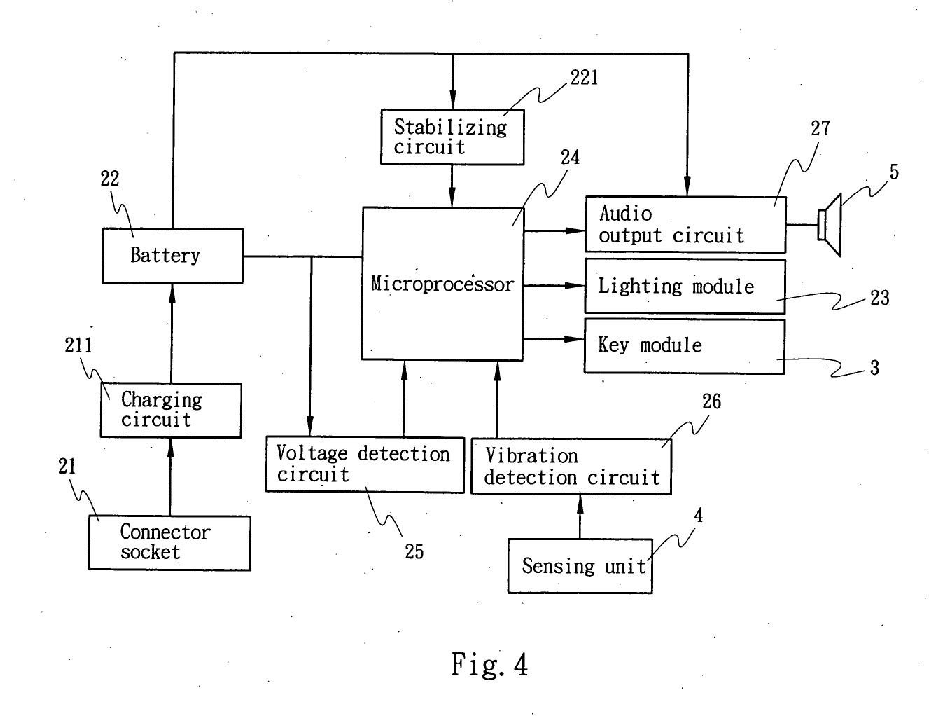

Please refer to FIGS. 1 to 4. The present invention includes a housing 1, a circuit board 2, a press key module 3, a sensing unit 4 and an alarm unit 5. The housing 1 is a flat housing composed of a base seat 11 and an upper cover 12 mated with each other to define an interior space. The bottom of the base seat 11 is adhered to a surface of the notebook 6 via a high-adhesion bonding plate 111. The upper cover 12 is formed with multiple keyholes 121 and at least one slot 122. A shade 125 is fitted in the slot 122. At least one sidewall of the upper cover 12 is formed with sounding holes 123. In addition, the upper cover 12 is formed with an arced edge 124. The circuit board 2 is arranged in the housing 1 and connected to a battery 22 for supplying power to the circuit board 2. A connector socket 21 ( which can be a USB socket ) is arranged on one side of the circuit board 2. The socket 21 outward extends through the housing 1. Via a corresponding USB plug, the socket 21 can be connected to an external power supply. The circuit board 2 is composed of a charging circuit 211, a stabilizing circuit 221, a lighting module 23, a microprocessor 2, a voltage detection circuit 25, a vibration detection circuit 26 and an audio output circuit 27. The charging circuit 211 is positioned between the connector socket 21 and the battery 22 for taking the external power from the connector socket 21 and converting the external power into suitable voltage to charge the battery 22. The stabilizing circuit 221 is disposed between the battery 22 and the microprocessor 24 for converting the output of the battery 22 into more stable voltage usable for the microprocessor 24. The microprocessor 24 receives the respective control and sensing signals and outputs relative control state display signals and alarm signals. The lighting module 23 at least includes a green light-emitting diode 231 and a red light-emitting diode 232. Alternatively, the lighting module 23 can include other light-emitting diode with different color. The lighting module 23 receives the control state display signals output from the microprocessor 24 to show the different control states via different colors. The voltage detection circuit 25 serves to detect the voltage of the battery 22. The vibration detection circuit 26 serves to amplify external vibration signals. The audio output circuit 27 serves to amplify the alarm signals output from the microprocessor 24. The press key module 3 includes multiple numeral keys 31 and at least one function key 32. These keys 31, 32 extend through the keyholes 121 of the housing 1 to contact with the related control parts of the circuit board 2 via several pieces of foam rubber 33 and several leaf springs 34. A user can input a circuit activation password via the numeral keys 31. The function key 32 is used to switch the functions of the circuit. The sensing unit 4 is connected to the vibration detection circuit 26. The sensing unit 4 includes a steel ball 42 and a sensing cell 41 on which the steel ball 42 is rested. The sensing cell 41 serves to sense the rolling of the steel ball 42 due to tilting or vibration and output a vibration signal. The vibration signal is amplified by the vibration detection circuit 26 and input to the microprocessor 24. The alarm unit 5 can be a buzzer, a speaker or a sound generator disposed beside the sounding holes 123 of the housing 1. The alarm unit 5 is connected to the audio output circuit 27 of the circuit board 2, which amplifies the alarm signals. The alarm unit 5 serves to convert the amplified alarm signals into real sound.

In use, by means of the function key 32 of the press key module 3, a user can change the burglarproof setting or discharge/change the password. The numeral keys 31 are used to input the burglarproof password. The voltage detection circuit 25 of the circuit board 2 serves to detect the voltage of the battery 22. In case of too low voltage, the lighting module 23 will emit a different color of light or flicker to remind a user to charge the battery 22. In the case that the sensing unit 4 senses continuous tilting or vibration (abnormal state), the sensing unit 4will output a vibration signal to the vibration detection circuit 26. The vibration detection circuit 26 amplifies the vibration signal and input to the microprocessor 24. The microprocessor 24 judges and processes the signal to output an alarm signal. The audio output circuit 27 outputs the alarm signal to the alarm unit 5 to convert the alarm signal into alarm sound. Therefore, a burglarproof effect can be achieved.

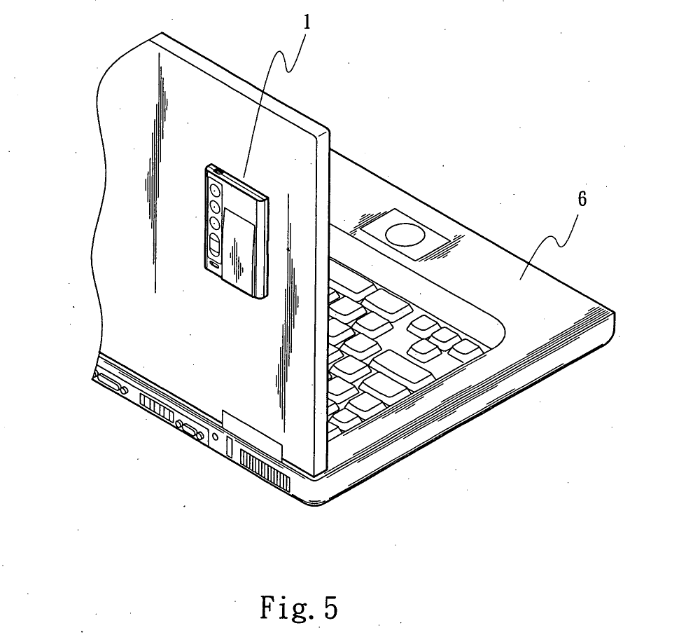

Referring to FIG. 5, the alarm device of the present invention is lightweight and thin and is directly combined with the notebook 6. Therefore, it is easy to carry the notebook with the alarm device. In addition, the arced edge 124 of the upper cover 12 makes it difficult for a burglar to disassemble/damage the alarm device. A user can set a numeral password to achieve a burglarproof effect without additionally carrying a key. This is convenient to the user. Moreover, the sounding holes 123 are formed on the vertical sidewall of the housing 1 so that a burglar cannot easily shade the sounding holes 123. Also, the sound can be loudly spread via the housing of the notebook 6 to achieve better warning effect.

In practical use, the alarm unit can be alternatively a light-emitting unit or a wireless transmission unit. The alarm unit is controlled by the microprocessor 24 to emit a glaring warning light to scare the burglar or contact with outer side via wireless transmission.

The above embodiments are only used to illustrate the present invention, not intended to limit the scope thereof. Many modifications of the above embodiments can be made without departing from the spirit of the present invention.

What is claimed is:

1. An alarm device for a notebook, comprising:
a housing which is a flat housing having an interior space, a bottom face of the housing being attachable to a surface of the notebook;
a circuit board arranged in the interior space of the housing and connected to a battery for supplying power to the circuit board, the circuit board serving to accept respective control signals and sensing signals to output an alarm signal;
a press key module disposed on a surface of the housing, the press key module serving to generate control signals input to the circuit board for controlling the related electronic parts to provide respective preset functions;
a sensing unit serving to sense respective tilting or vibration states and output a sensing signal to the circuit board; and
an alarm unit serving to accept the alarm signal output from the circuit board to produce corresponding alarm motion.

2. The alarm device for the notebook as claimed in claim 1, wherein the alarm unit includes a sound generator.

3. The alarm device for the notebook as claimed in claim 2, wherein a sidewall of the housing is formed with sounding through holes near the sound generator.

4. The alarm device for the notebook as claimed in claim 1, wherein the alarm unit includes a light-emitting unit.

5. The alarm device for the notebook as claimed in claim 1, wherein the housing is composed of a base seat and an upper cover mated with each other to define the interior space.

6. The alarm device for the notebook as claimed in claim 3, wherein the housing is composed of a base seat and an upper cover mated with each other to define the interior space.

7. The alarm device for the notebook as claimed in claim 1, wherein a lower side of the housing is adhered to a surface of the notebook via an adhesive bonding plate.

8. The alarm device for the notebook as claimed in claim 3, wherein a lower side of the housing is adhered to a surface of the notebook via an adhesive bonding plate.

9. The alarm device for the notebook as claimed in claim 5, wherein a lower side of the housing is adhered to a surface of the notebook via an adhesive bonding plate.

10. The alarm device for the notebook as claimed in claim 6, wherein a lower side of the housing is adhered to a surface of the notebook via an adhesive bonding plate.

11. The alarm device for the notebook as claimed in claim 1, wherein the circuit board includes a lighting module for showing the operation of the press keys of the press key module or the states of the circuit board itself.

12. The alarm device for the notebook as claimed in claim 3, wherein the circuit board includes a lighting module for showing the operation of the press keys of the press key module or the states of the circuit board itself.

13. The alarm device for the notebook as claimed in claim 5, wherein the circuit board includes a lighting module for showing the operation of the press keys of the press key module or the states of the circuit board itself.

14. The alarm device for the notebook as claimed in claim 6, wherein the circuit board includes a lighting module for showing the operation of the press keys of the press key module or the states of the circuit board itself.

15. The alarm device for the notebook as claimed in claim 7, wherein the circuit board includes a lighting module for showing the operation of the press keys of the press key module or the states of the circuit board itself.

16. The alarm device for the notebook as claimed in claim 8, wherein the circuit board includes a lighting module for showing the operation of the press keys of the press key module or the states of the circuit board itself.

17. The alarm device for the notebook as claimed in claim 9, wherein the circuit board includes a lighting module for showing the operation of the press keys of the press key module or the states of the circuit board itself.

18. The alarm device for the notebook as claimed in claim 10, wherein the circuit board includes a lighting module for showing the operation of the press keys of the press key module or the states of the circuit board itself.

19. The alarm device for the notebook as claimed in claim 1, wherein press key module includes multiple numeral keys and at least one function key, the numeral keys being for a user to input a circuit activation password, the function key being for a user to switch the functions of the circuit.

20. The alarm device for the notebook as claimed in claim 3, wherein press key module includes multiple numeral keys and at least one function key, the numeral keys being for a user to input a circuit activation password, the function key being for a user to switch the functions of the circuit.

21. The alarm device for the notebook as claimed in claim 5, wherein press key module includes multiple numeral keys and at least one function key, the numeral keys being for a user to input a circuit activation password, the function key being for a user to switch the functions of the circuit.

22. The alarm device for the notebook as claimed in claim 7, wherein press key module includes multiple numeral keys and at least one function key, the numeral keys being for a user to input a circuit activation password, the function key being for a user to switch the functions of the circuit.

23. The alarm device for the notebook as claimed in claim 9, wherein press key module includes multiple numeral keys and at least one function key, the numeral keys being for a user to input a circuit activation password, the function key being for a user to switch the functions of the circuit.

24. The alarm device for the notebook as claimed in claim 11, wherein press key module includes multiple numeral keys and at least one function key, the numeral keys being for a user to input a circuit activation password, the function key being for a user to switch the functions of the circuit.

25. The alarm device for the notebook as claimed in claim 13, wherein press key module includes multiple numeral keys and at least one function key, the numeral keys being for a user to input a circuit activation password, the function key being for a user to switch the functions of the circuit.

26. The alarm device for the notebook as claimed in claim 1, wherein a connector socket is arranged on the circuit board and connectable to an external power supply via a connector, whereby the external power supply can charge the battery.

27. The alarm device for the notebook as claimed in claim 3, wherein a connector socket is arranged on the circuit board and connectable to an external power supply via a connector, whereby the external power supply can charge the battery.

28. The alarm device for the notebook as claimed in claim 5, wherein a connector socket is arranged on the circuit board and connectable to an external power supply via a connector, whereby the external power supply can charge the battery.

29. The alarm device for the notebook as claimed in claim 7, wherein a connector socket is arranged on the circuit board and connectable to an external power supply via a connector, whereby the external power supply can charge the battery.

30. The alarm device for the notebook as claimed in claim 9, wherein a connector socket is arranged on the circuit board and connectable to an external power supply via a connector, whereby the external power supply can charge the battery.

31. The alarm device for the notebook as claimed in claim 11, wherein a connector socket is arranged on the circuit board and connectable to an external power supply via a connector, whereby the external power supply can charge the battery.

32. The alarm device for the notebook as claimed in claim 13, wherein a connector socket is arranged on the circuit board and connectable to an external power supply via a connector, whereby the external power supply can charge the battery.

33. The alarm device for the notebook as claimed in claim 19, wherein a connector socket is arranged on the circuit board and connectable to an external power supply via a connector, whereby the external power supply can charge the battery.

34. The alarm device for the notebook as claimed in claim 1, wherein the upper cover of the housing is formed with an arced edge.

35. The alarm device for the notebook as claimed in claim 3, wherein the upper cover of the housing is formed with an arced edge.

36. The alarm device for the notebook as claimed in claim 5, wherein the upper cover of the housing is formed with an arced edge.

37. The alarm device for the notebook as claimed in claim 7, wherein the upper cover of the housing is formed with an arced edge.

38. The alarm device for the notebook as claimed in claim 8, wherein the upper cover of the housing is formed with an arced edge.

39. The alarm device for the notebook as claimed in claim 9, wherein the upper cover of the housing is formed with an arced edge.

40. The alarm device for the notebook as claimed in claim 11, wherein the upper cover of the housing is formed with an arced edge.

41. The alarm device for the notebook as claimed in claim 12, wherein the upper cover of the housing is formed with an arced edge.

42. The alarm device for the notebook as claimed in claim 13, wherein the upper cover of the housing is formed with an arced edge.

43. The alarm device for the notebook as claimed in claim 19, wherein the upper cover of the housing is formed with an arced edge.

44. The alarm device for the notebook as claimed in claim 26, wherein the upper cover of the housing is formed with an arced edge.
